(19) United States
(12) Patent Application Publication
(10) Pub. No.: US 2025/0264709 A1
(43) Pub. Date: Aug. 21, 2025

(54) OPTICAL SYSTEM WITH INTEGRATED LASER RANGEFINDER

(71) Applicant: Garmin International, Inc., Olathe, KS (US)

(72) Inventors: Joe Ryan Dejmal, Olathe, KS (US); Chad A. VanCamp, Olathe, KS (US); Joseph T. Lunde, Olathe, KS (US); Tyler A. Troyer, Olathe, KS (US); Peter A. Hindman, Olathe, KS (US); Jeremy J. Ell, Olathe, KS (US)

(21) Appl. No.: 19/035,086

(22) Filed: Jan. 23, 2025

Related U.S. Application Data
(60) Provisional application No. 63/555,689, filed on Feb. 20, 2024.

(51) Int. Cl. G02B 23/12; G01S 7/51; G01S 17/08; G01S 17/86; G01S 19/42

(52) U.S. Cl. CPC G02B 23/12; G01S 7/51; G01S 17/08; G01S 17/86; G01S 19/42

(57) ABSTRACT

An optical system comprising a global navigation satellite system (GNSS) receiver, a laser rangefinder, an orientation sensor, a display, a memory, and a processor. The processor is configured to show a visual scene viewed through the optical system, mark a target location in the visual scene using the laser rangefinder in response to receiving a mark command from a user to mark the target location, create a waypoint of the target location based on data from the GNSS receiver, the laser rangefinder, and the orientation sensor, store the waypoint in the memory, load the waypoint in response to receiving a load command to load the waypoint from the user, and show an augmented reality overlayed on a different visual scene viewed through the optical system, wherein the augmented reality includes an indicator to guide the user to the waypoint.

### RELATED APPLICATIONS

This application claims priority to U.S. provisional application 63/555,689 filed Feb. 20, 2024, the contents of which are hereby incorporated by reference herein for all purposes.

### TECHNICAL FIELD

The present disclosure relates generally to an optical system with an integrated laser rangefinder.

### BACKGROUND

A rangefinder can measure a distance between a user and a target object. It can be used in various applications including photography, climbing, hiking, hunting, golfing, and surveying, for example.

### BRIEF DESCRIPTION OF THE DRAWINGS

The detailed description references the accompanying figures. The use of the same reference numbers in different instances in the description and the figures may indicate similar or identical items. In addition, the proportion and the relative scale of the elements provided in the figures are intended to illustrate various embodiments of the present disclosure and are not to be used in a limiting sense.

FIG. 1 illustrates an example of a user using an optical system.

FIG. 2 is a view of an optical system.

FIG. 3 is a block diagram of an optical system.

FIG. 4 illustrates an example of a display showing augmented reality including an indicator overlayed on a number of visual scenes viewed through an optical system.

FIG. 5 illustrates an example of a display showing augmented reality including a direction indicator and a vertical angle indicator viewed through an optical system.

FIG. 6 illustrates an example of a display showing augmented reality including a stop indicator viewed through an optical system.

FIG. 7 illustrates an example of an area of certainty.

FIG. 8 illustrates an example of a user using an optical system.

FIG. 9 illustrates examples of a display in a monocular of an optical system.

FIG. 10 illustrates an example of a display showing augmented reality viewed through an optical system.

FIG. 11 illustrates an example of a display showing augmented reality viewed through an optical system.

FIG. 12 illustrates an example of a display showing augmented reality viewed through an optical system.

FIG. 13 illustrates an example of a display showing augmented reality viewed through an optical system.

FIG. 14 illustrates an example of a display showing augmented reality viewed through an optical system.

FIG. 15 illustrates an example of a display showing augmented reality viewed through an optical system.

FIG. 16 illustrates an example of a display showing augmented reality viewed through an optical system.

FIG. 17 illustrates an example of a display showing augmented reality viewed through an optical system.

FIG. 18 illustrates an example of a display showing augmented reality viewed through an optical system.

FIG. 19 illustrates an example of a display showing augmented reality viewed through an optical system.

FIG. 20 illustrates an example of a display showing augmented reality viewed through an optical system.

FIG. 21 illustrates an example of a display showing augmented reality viewed through an optical system.

### DETAILED DESCRIPTION

The present disclosure includes an optical system comprising a global navigation satellite system (GNSS) receiver, a laser rangefinder, an optical system that transmits a visual scene, an orientation sensor, a display, a memory, and a processor. The optic is configured to show a visual scene viewed through the optical system with an overlaid display, mark a target location in the visual scene using the laser rangefinder in response to receiving a mark command from a user to mark the target location, create a waypoint of the target location based on data from the GNSS receiver, the laser rangefinder, the magnetometer, and the tilt sensor, store the waypoint in the memory, load the waypoint in response to receiving a load command to load the waypoint from the user, and show an augmented reality overlayed on the visual scene viewed through the optical system overlaid on the display, wherein the augmented reality includes an indicator to guide the user to the waypoint. As used herein, the term “augmented reality” as a noun refers to digital content that is overlayed on a display or image of a real world scene.

The combination of pure optics, global positioning system (GPS) positioning, laser ranging, and/or mapping, along with magnetometers, accelerometers, and/or ambient light sensors create an experience for the user which assists in solving many real-world problems for the user. While some laser rangefinders have attempted to perform similar functions, they do not create a user experience as described herein.

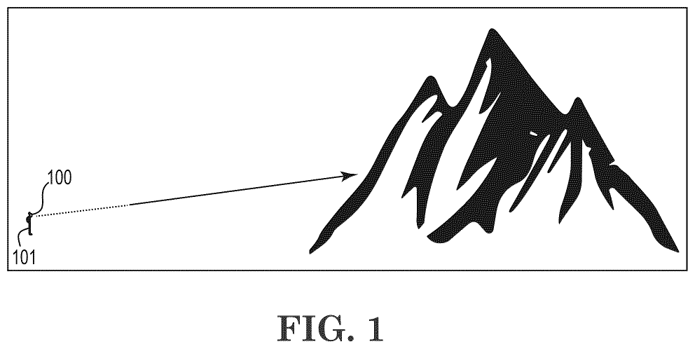

FIG. 1 illustrates an example of a user 101 using an optical system 100. The optical system 100 can provide enlarged images of distant objects while viewing a waypoint. In the present example, the user can mark and/or view the waypoint on the mountain through the optical system 100.

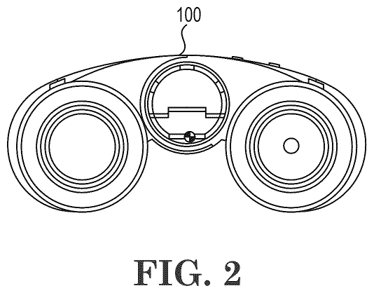

FIG. 2 is a view of an optical system 100. Although the optical system 100 is illustrated as binoculars, the optical system 100 can also be a monocular, fixed and variable-zoom optics, and/or a laser range finding device.

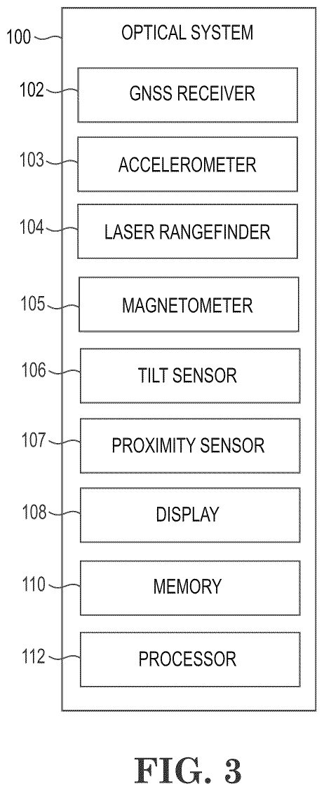

FIG. 3 is a block diagram of an optical system 100. The optical system 100 can include a GNSS receiver 102, an accelerometer 103, a laser rangefinder 104, a magnetometer 105, a tilt sensor 106, a proximity sensor 107, a display 108, a memory 110, and/or a processor 112. The GNSS receiver 102, the accelerometer 103, the laser rangefinder 104, the magnetometer 105, the tilt sensor 106, the proximity sensor 107, the display 108, and the memory 110 can all be coupled to the processor 112. Although tilt sensor 106 and magnetometer 105 are utilized as examples of an orientation sensor, any position, attitude, and inclination sensors may be utilized to help determine the orientation of the system 100 to provide the functionality described herein. Examples of such orientation systems may include inertial measurement units (IMUs), gyroscopes, accelerometers, and electronic compasses, which can independently or collectively provide position, angular velocity, and inclination data to enhance the accuracy of the system 100 in determining its orientation relative to the Earth's surface.

The processor 112 provides processing functionality for the optical system 100 and can include any number of processors, micro-controllers, circuitry, field programmable gate array (FPGA) or other processing systems, and resident or external memory for storing data, executable code, and other information. The processor 112 is not limited to being formed from any particular material or the processing mechanisms employed therein and, as such, can be implemented via semiconductor(s) and/or transistors (e.g., using electronic integrated circuit (IC) components), and so forth.

The processor 112 can execute one or more software programs embodied in a non-transitory computer readable medium (e.g., memory 110) that implement techniques described herein. Examples of such techniques include showing a visual scene viewed through the optical system 100 overlaid on the display 108, marking a target location in the visual scene using the laser rangefinder 104 in response to receiving a mark command from a user (e.g., user 101 in FIG. 1) to mark the target location, creating a waypoint of the target location based on data from the GNSS receiver 102, the laser rangefinder 104, the magnetometer 105, and/or the tilt sensor 106, storing the waypoint in the memory 110, loading the waypoint in response to receiving a load command from the user to load the waypoint, and showing an augmented reality overlayed on a different visual scene viewed through the optical system 100 overlaid on the display 108. The augmented reality can include an indicator to guide the user to the waypoint. As used herein, marking the target with the laser rangefinder means that the user is indicating to the optical system that a desired target is centered in view and that the laser rangefinder should be engaged in attempt to determine a distance to the target, whether the laser rangefinder is successfully able to determine the distance or not.

Using both the GNSS receiver 102 and the laser rangefinder 104 to determine the precise location of a waypoint ensures that the target location can be accurately identified and recalled, even after the optical system 100 has moved from its original position. The GNSS receiver 102 provides geographic coordinates, such as latitude, longitude, and elevation, which establish the absolute position of the optical system 100 at the time the waypoint is created. The laser rangefinder 104, when engaged, determines the distance from the optical system 100 to the target location within the visual scene, allowing the system to calculate the relative position of the waypoint with respect to the user's initial location. By combining these data points, and optionally other data described below, the system can establish a precise waypoint that remains valid and accessible from other locations, by other devices, without relying on the user's memory or visual recognition of landmarks.

Further, the processor 112 can create the waypoint by accessing map data and/or determine a distance to the waypoint based on the map data and/or other data. Data from the laser rangefinder 104 can include a distance between the laser rangefinder 104 and the target location of the waypoint. In a number of embodiments, the data from the laser rangefinder 104 can indicate that a distance between the laser rangefinder 104 and the target location is beyond a maximum range of the laser rangefinder 104 and the processor 112 can access the map data and interface the data from the GNSS receiver 102, the laser rangefinder 104, the magnetometer 105, and the tilt sensor 106 with the map data to draw a line that intersects with earth to mark the target location that is out of range of the laser rangefinder 104.

This functionality allows for flexible waypoint marking in diverse environments, where targets may be difficult to approach directly. By using map data to compensate for the limitations of the laser rangefinder 104, the optical system 100 can mark waypoints in situations where physical obstacles or long distances would otherwise make precise targeting impractical. The resulting waypoint can then be stored in memory 110 for later use, with the processor 112 generating augmented reality overlays to guide the user back to the target.

The augmented reality can include the distance to the waypoint and/or map information. In a number of embodiments, the processor 112 can transmit the waypoint to another device, such as a handheld navigator, smartphone, etc.

The memory 110 can be a tangible, computer-readable storage medium that provides storage functionality to store various data and/or program code associated with an operation, such as software programs and/or code segments, or other data to instruct the processor 112, and possibly other components of the optical system 100, to perform the functionality described herein. The memory 110 can store data, such as program instructions for operating the optical system 100 including its components, and so forth. The memory 110 can also store the waypoint. The memory 110 can further store a number of waypoints.

It should be noted that while a single memory 110 is described, a wide variety of types and combinations of memory (e.g., tangible, non-transitory memory) can be employed. The memory 110 can be integral with the processor 112, can comprise stand-alone memory, or can be a combination of both. Some examples of the memory 110 can include removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In a number of embodiments, the optical system 100 and/or the memory 110 can include removable integrated circuit card (ICC) memory, such as memory provided by a subscriber identity module (SIM) card, a universal subscriber identity module (USIM) card, a universal integrated circuit card (UICC), and so on.

The display 108 can display text, data, graphics, images, and other information. The display 108 may be a liquid crystal display (LCD), light-emitting diode (LED) display, light-emitting polymer (LEP) display, thin film transistor (TFT) display, gas plasma display, or any other type of display. The display 108 may be backlit such that it may be viewed in the dark or other low-light environments.

The display 108 may be arranged in any configuration within the optical system 100 to supplement, augment, overlay, or otherwise display digital information in combination with the visual scene. Display 108 may be used in combination with optics of the optical system 100 to facilitate the integration of digital information with a visual scene captured by the optics. The optics may include one or more beam combiners, mirrors, beam dividers, or insertion cubes configured to combine light from display 108 with light from the surrounding environment. The combined image is then directed to the user through one or more eyepieces, allowing the digital information to be superimposed onto the visual scene. In some embodiments, the optics may adjust the relative positioning or focus of the combined light paths to ensure that the digital content from display 108 is aligned with the user's view of the environment.

The optical system 100 may include lenses, mirrors, or prisms that form a single or multi-stage optical path, directing light from both the real-world scene and display 108 to the user's eye. In rangefinders, magnified monoculars, binoculars, and similar devices, this optical path typically begins with an objective lens that collects light from the external environment and focuses it along a defined axis. Intermediate optical elements, such as mirrors or prisms, may be used to fold or extend the optical path to achieve a more compact device form factor while maintaining the required magnification and clarity. However, optical system 100 may employ any design capable of optically capturing a scene that may be used in combination with display 108.

Display 108 may be used in combination with magnified optics, including lenses forming part of the optical system 100, to present digital information alongside a magnified view of a scene. The lenses may be configured to magnify light from the external environment and direct it through the optical path toward the eyepiece. Display 108 may be positioned within this optical path to introduce digital content, which is combined with the magnified image using optical elements such as beam combiners or mirrors. The magnification provided by the lenses may also be applied to the digital information from display 108 to maintain proportional scaling between the digital content and the magnified scene.

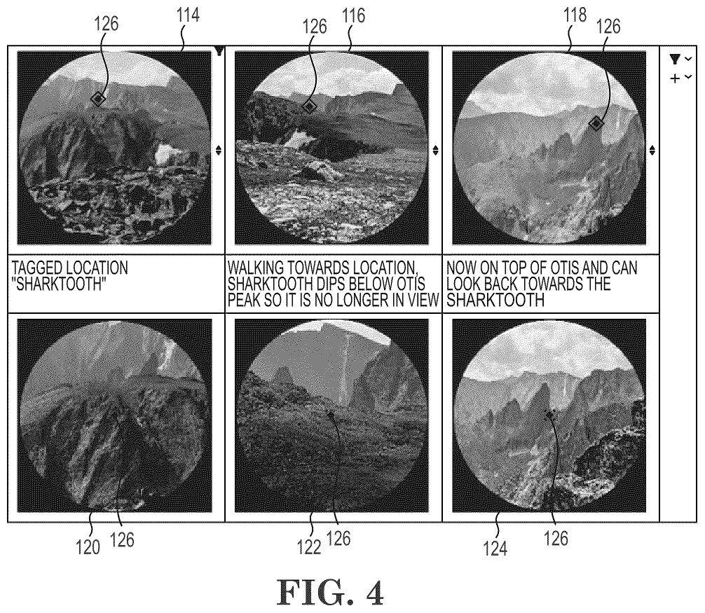

The proximity sensor 107 can be used to determine if there is an object blocking a receiver of the laser rangefinder 104. In a number of embodiments, an internal test can verify the receiver is fully functional and another sensor can be used to determine if there is an object blocking the receiver. The laser rangefinder 104 can be verified to be functional, clear of objects, and then start ranging. FIG. 4 illustrates an example of a display (e.g., display 108 in FIG. 3) showing augmented reality including an indicator 126 overlayed on a number of visual scenes 114, 116, 118, 120, 122, and 124 viewed through an optical system (e.g., optical system 100 in FIGS. 1, 2, and 3). In visual scene 114, a user (e.g., user 101 in FIG. 1) can mark a location in the visual scene 114. The marked location can be named Sharktooth, for example, by the user and can be shown as indicator 126. The indicator 126 can be displayed as a particular symbol or in a particular color. For example, the indicator 126 can be diamond shaped and/or red. In a number of embodiments, the indicator 126 can include a filled in first diamond enclosed by an outlined second diamond. Visual scene 120 can be a magnified version of visual scene 114 and can include the indicator 126. However, the indicator 126 can include user-selected symbols or context-specific symbols selected by the system 100. For instance, indicator 126 can be location-specific symbols (campsites, parking, rivers, etc.), object-specific symbols (deer, duck, animals, bear, vehicles,), combinations thereof, and the like.

The user can walk towards the marked location and then use the optical system to find the marked location, which shows visual scene 116. In visual scene 116, Sharktooth is obstructed by Otis Peak so that Sharktooth is no longer in view. Although Sharktooth is not present in the visual scene 116, the indicator 126 still is present to guide the user to Sharktooth. Visual scene 122 can be a magnified version of visual scene 116 and can include the indicator 126.

Once the user reaches the top of Otis Peak, the user can find the marked location using the optical system, which shows visual scene 118. In visual scene 118, Sharktooth is no longer obstructed by Otis Peak and the indicator 126 can be seen on Sharktooth. Visual scene 124 can be a magnified version of visual scene 118 and can include the indicator 126.

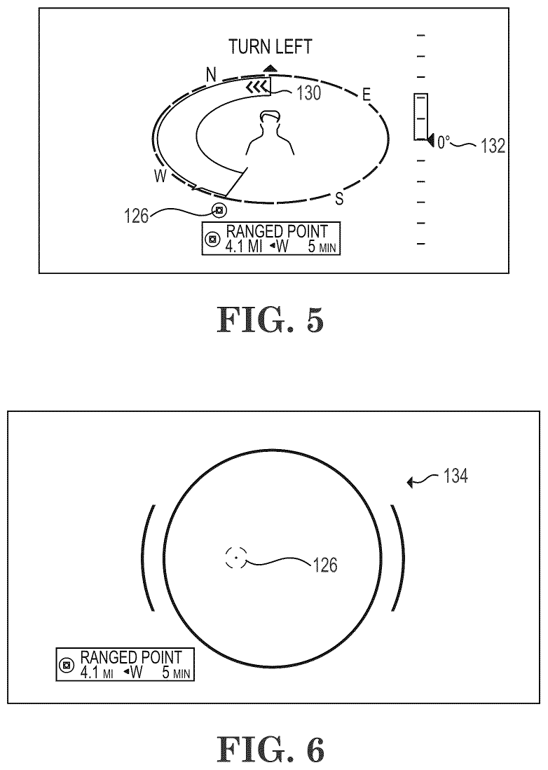

FIG. 5 illustrates an example of a display (e.g., display 108 in FIG. 3) showing augmented reality including a direction indicator 130 and a vertical angle indicator 132 viewed through an optical system (e.g., optical system 100 in FIGS. 1, 2, and 3). The present figure shows augmented reality whereby a user (e.g., user 101 in FIG. 1) desires to visually recall a waypoint. The direction indicator 130 and the vertical angle indicator 132 show to the user which direction to turn and the vertical angle at which to position the optical system to locate the waypoint, whether obstructed or clear view, to the user. The augmented reality changes dynamically as the user turns and adjusts the angle, showing the user that they are making positive or negative changes to lock in visually on the waypoint.

Display 108 presents the direction indicator 130 and vertical angle indicator 132 by dynamically overlaying these elements within the user's view through the optical system 100. As the user turns or adjusts the angle of the optical system, display 108 updates the position and orientation of the indicators in real time to reflect changes relative to the waypoint. The direction indicator 130 guides the user toward the correct horizontal bearing by adjusting its position in the field of view, while the vertical angle indicator 132 moves to show the necessary upward or downward adjustment to align with the waypoint. These digital overlays remain visible within the combined optical path, providing continuous visual feedback as the user moves, enabling precise alignment with the desired waypoint regardless of whether it is in direct view or obstructed.

The direction indicator 130 can direct a user in which direction to turn the optical system to view the waypoint, which dynamically changes as the optical system is turned. The direction indicator 130 can include an arrow pointing in the direction to turn the optical system or a written direction, for example, a “W” for west and/or “Turn Left”. In a number of embodiments, the direction indicator 130 can further include a direction of travel, which can be the current direction the user is traveling in and/or indicators of north, east, south, and west. The direction indicator can be displayed in a color, for example, green. An indicator 126 of the waypoint can be displayed to further direct the user in which direction to turn and how far to turn.

The vertical angle indicator 132 can direct the user in which direction to adjust an angle of the optical system to view the waypoint, which dynamically changes as the angle is adjusted. In a number of embodiments, the vertical angle indicator 132 can include a numerical degree call out. A number of tick marks representing degrees can also be included in the augmented reality.

The name of the waypoint in view, for example “Ranged Point” in FIG. 5, can be indicated via augmented reality on the display over a visual scene. The augmented reality can further include a distance to the waypoint. As illustrated in FIG. 5, the optical system along with the user can be 4.1 miles from the waypoint. The time to get to the waypoint can also be displayed, for example, the minutes or hours estimated to reach the marked waypoint. FIG. 6 illustrates an example of a display (e.g., display 108 in FIG. 3) showing augmented reality including a stop indicator 134 viewed through the optical system (e.g., optical system 100 in FIGS. 1, 2, and 3). When the waypoint is in the field of view, the augmented reality changes to include the stop indicator 134, indicating to a user (e.g., user 101 in FIG. 1) to stop moving.

The stop indicator 134 can include a full circle and/or a partial circle outside of the full circle, as shown in FIG. 6. The stop indicator can be a color to distinguish it from the visual scene. For example, the stop indicator can be green. An indicator 126 of the waypoint can be displayed to further direct the user where in the user's field of view to direct their attention to see the waypoint.

The name of the waypoint in view, for example “Ranged Point” in FIG. 6, can be indicated via augmented reality on the display over a visual scene. The augmented reality can further include a distance from the waypoint. As illustrated in FIG. 6, the optical system along with the user can be 4.1 miles from the waypoint. The time to get to the waypoint can also be displayed.

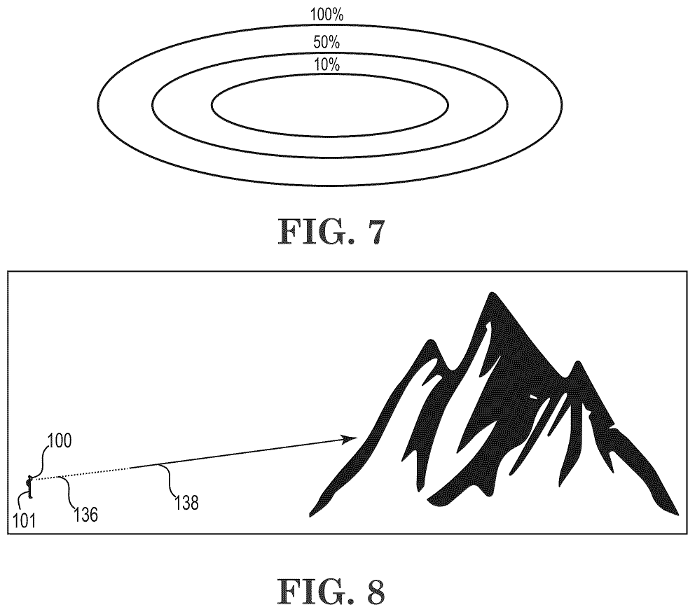

FIG. 7 illustrates an example of an area of certainty. The area of certainty can be used when finding a waypoint. A waypoint is a latitude, longitude, and altitude of a given position. A waypoint can further include maximum and typical error associated with sensors used to generate the waypoint. The errors are then added together to generate a waypoint which includes areas of certainty. The shape created using the maximum error from all the sensors, will include the waypoint 100% of the time. By using statistics, an optical system (e.g., optical system in FIGS. 1, 2, and 3) can direct a user (e.g., user 101 in FIG. 1) to start a waypoint search in a smaller area, and then direct the user to widen the search to ensure that the waypoint can be found.

For example, a magnetometer (e.g., magnetometer 105 in FIG. 3) might have plus or minus five degrees of maximum error which would result in plus or minus 140 meters lateral error at one mile. A global positioning system (GPS) might have a maximum position error of plus or minus fifteen meters. Adding these together creates a shape about thirty meters wide and about 280 meters long for 100% certainty. The magnetometer might have a typical error of plus or minus a degree and the GPS error might typically be within plus or minus three meters. This would result in a much smaller search area of about six meters wide and about fifty-five meters long.

FIG. 8 illustrates an example of a user 101 using an optical system 100. The optical system 100 can be used to identify points of interest based on gathering data from sensors of the optical system 100 to determine a position and an orientation of the optical system 100. The position and orientation of the optical system 100 can be correlated to map data to generate a list of possible points of interest. This allows the optical system 100 to determine a position of points out of range for the laser ranging capability of the optical system 100. For example, the dotted line 136 can represent points within range for a laser rangefinder (e.g., laser rangefinder 104 of FIG. 3) of the optical system 100. Solid line 138 can represent points out of range for the laser rangefinder. In essence, using the user's known GPS location, compass heading, and angle of inclination/declination as the user looks through the optical system 100, a line can be drawn that intersects with the earth, potentially miles away. This allows points that are out of range of the laser rangefinder to be marked.

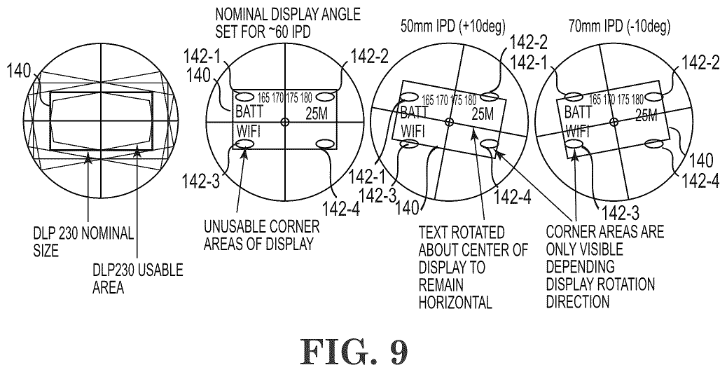

FIG. 9 illustrates examples of a display in a monocular of an optical system (e.g., optical system 100 in FIGS. 1, 2, 3 and 8). In the optical system (e.g., binoculars), an interpupillary distance (IPD) of a user (e.g., user 101 in FIGS. 1 and 8) determines the spacing between the two monocular tubes. When using a hinge design, each monocular will rotate as the IPD is adjusted to fit the user. For example, if the monoculars are rotated about the hinge a positive ten degrees, the IPD can be fifty millimeters and if the monoculars are rotated about the hinge a negative ten degrees, the IPD can be seventy millimeters. At a nominal display angle, the IPD can be sixty millimeters.

If a display (e.g., display 108 in FIG. 3) is fixed inside one or both of the monoculars, information (e.g., data) on the display will rotate as the IPD is adjusted. To address this issue, an accelerometer (e.g., accelerometer 103 in FIG. 3) can be placed in each monocular of the optical system. A reading can be taken on each accelerometer at the same time and from those readings, the angle of rotation can be determined. Based on this solution, the information on the display can be rotated to the angle of rotation to look appropriate to the user.

The display can include a usable area 140 where the user can read data and unusable areas 142-1, 142-2, 142-3, 142-4 where the user cannot read data. The optical system can include digital light processing (DLP) 230, which is a digital micromirror device with a 0.23 inch diagonal micromirror array. When the monoculars are rotated about the hinge, text included on the display can be rotated about the center of the display to remain horizontal for the user to read and to prevent the text from entering the unusable areas 142-1, 142-2, 142-3, and 142-4.

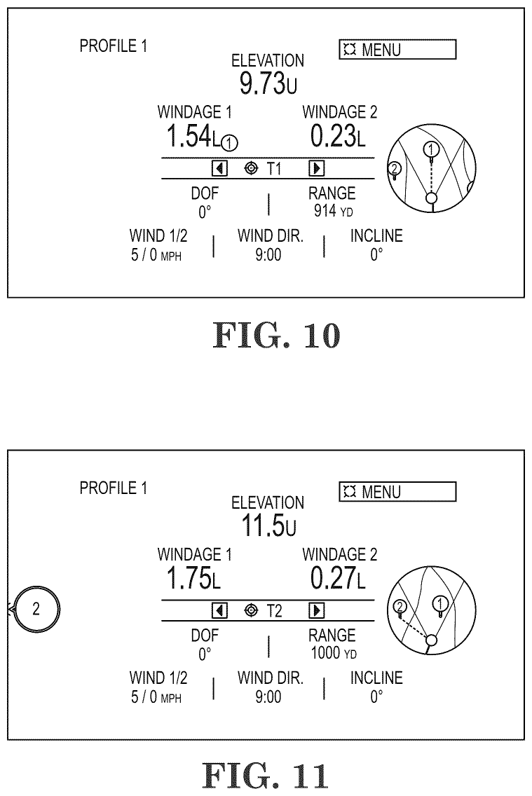

FIG. 10 illustrates an example of a display (e.g., display 108 in FIG. 3) showing augmented reality viewed through an optical system (e.g., optical system 100 in FIGS. 1, 2, 3, and 8). With the use of the optical system combined with onboard laser ranging technology and a ballistic solver that allows for one or more targets to be ranged and stored, the optical system can guide a user (e.g., user 101 in FIGS. 1 and 8) to step through setting and storing targets as waypoints, with ballistic solutions for each target based on a position of the user to a pre-determined target. As the user's position changes relative to the target, so then does the shooting solution required to precisely engage that target with a firearm such as a rifle.

In FIG. 10, the shooting solution for target one (e.g., T1 and/or 1) is shown. The shooting solution can be based on a particular profile, for example, profile 1. Which can be tailored to a particular user, gun, ammunition, bow, or arrow. The shooting solution can include elevation, windage 1, windage 2, direction of fire (DOF), range, wind speed, wind direction, and/or incline. The display can further include a map. Using the map, the user can see that target two (e.g., T2 and/or 2) is close by.

FIG. 11 illustrates an example of a display (e.g., display 108 in FIG. 3) showing augmented reality viewed through an optical system (e.g., optical system 100 in FIGS. 1, 2, 3, and 8). In FIG. 11, the shooting solution for target two (e.g., T2 and/or 2) is shown. The shooting solution can be based on profile 1. The shooting solution can include elevation, windage 1, windage 2, depth of field (DOF), range, wind speed, wind direction, and/or incline. The user can see both target two and target one (e.g., T1 and/or 1) on a map.

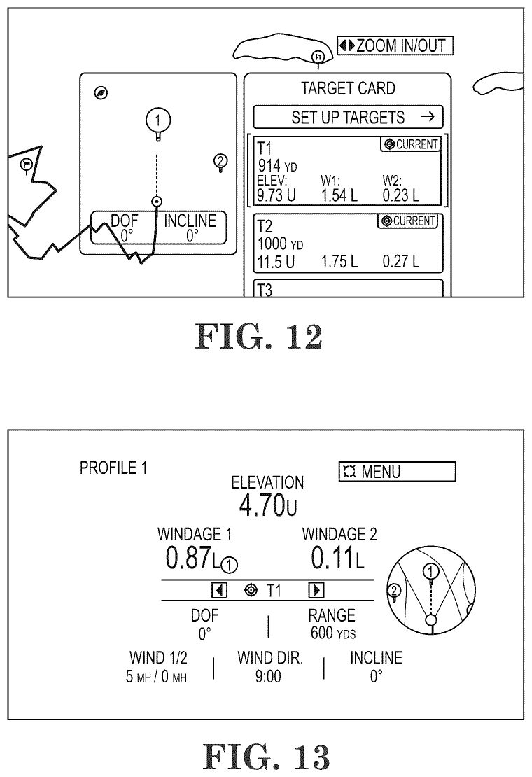

FIG. 12 illustrates an example of a display (e.g., display 108 in FIG. 3) showing augmented reality viewed through an optical system (e.g., optical system 100 in FIGS. 1, 2, 3, and 8). The optical system can calculate a wind direction and/or a user (e.g., user 101 in FIGS. 1 and 8) can determine the wind direction using a compass and manually enter a compass value of wind origination into the optical system. The wind direction, wind speed, and/or a direction of fire to a target can be used to calculate a windage hold for shooting the target.

FIG. 13 illustrates an example of a display (e.g., display 108 in FIG. 3) showing augmented reality viewed through an optical system (e.g., optical system 100 in FIGS. 1, 2, 3, and 8). Once the wind direction, wind speed, and/or a direction of fire to a target are used to calculate the windage hold for shooting the target, the shooting solution can be viewed. In FIG. 13, the shooting solution for target one (e.g., T1 and/or 1) is shown. The shooting solution is based on profile 1. The shooting solution includes elevation, windage 1, windage 2, depth of field (DOF), range, wind speed, wind direction, and/or incline. The display can further include a map including a number of targets.

FIG. 14 illustrates an example of a display (e.g., display 108 in FIG. 3) showing augmented reality viewed through an optical system (e.g., optical system 100 in FIGS. 1, 2, 3, and 8). FIG. 14 includes an arrow entry angle 150, flight apex of the arrow 152, and the arrow flight path 154 overlaid on a visual scene. The arrow entry angle 150 can be shown numerically (e.g., IMPACT 20°) and/or visually on an animal 156 via augmented reality.

The optical system 100 can calculate a line of sight, a horizontal compensated distance, which is a cosine of an angle to a target which determines a distance over which gravity has an effect on arrow drop along the arrow flight path 154, and/or the flight apex of the arrow 152. The flight apex of the arrow 152 can be indicated on the display illustrating a maximum height the arrow will reach along the arrow flight path 154.

The optical system can further calculate the arrow entry angle 150 into the target and multiple flight path points along the arrow's trajectory as the arrow approaches the target. The arrow entry angle 150 is important, as an arrow hitting high or low on a side of the animal 156 with a steep entry angle could make for a shot that can't penetrate cleanly through vitals of the animal 156. Multiple arrow height indicators along an arrow's flight path can help a user (e.g., user 101 in FIGS. 1 and 8) realize if the arrow will clear over or under a branch that could be positioned anywhere within the arrows path. These features are only capable of being shown with a high-resolution display that can create visual images for the archer to assess before taking the shot, thus making them a more ethical archer.

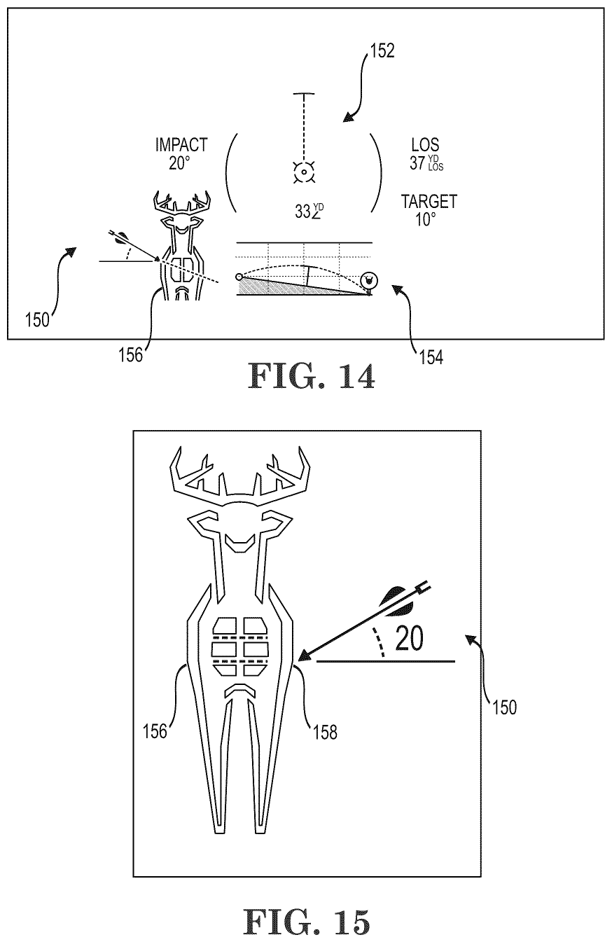

FIG. 15 illustrates an example of a display (e.g., display 108 in FIG. 3) showing augmented reality viewed through an optical system (e.g., optical system 100 in FIGS. 1, 2, 3, and 8). The display includes an animal 156 and an arrow entry angle 150 of twenty degrees. If one were to hit the animal 156 at entry point 158 via the twenty-degree arrow entry angle 150, the arrow may only hit one lung. This could result in a long tracking job, wound loss, or the animal 156 survives but in a weakened state for quite some time.

In a number of embodiments, arrow speed and kinetic energy with use provided grain weight can be calculated. While drag has a direct effect on the arrow, modern arrow ballistic calculations do not account for the effect of gravity accelerating or decelerating the arrow, if shot at an angle steeper than a few degrees. An arrow that accelerates as it moves downward with gravity will not decelerate as much with drag as gravity is working to counteract that effect. Therefore the arrow retains more speed over the horizontal distance, thereby dropping less on its travel to the target. This can result in an arrow impacting high on the target or low on the target for an uphill shot.

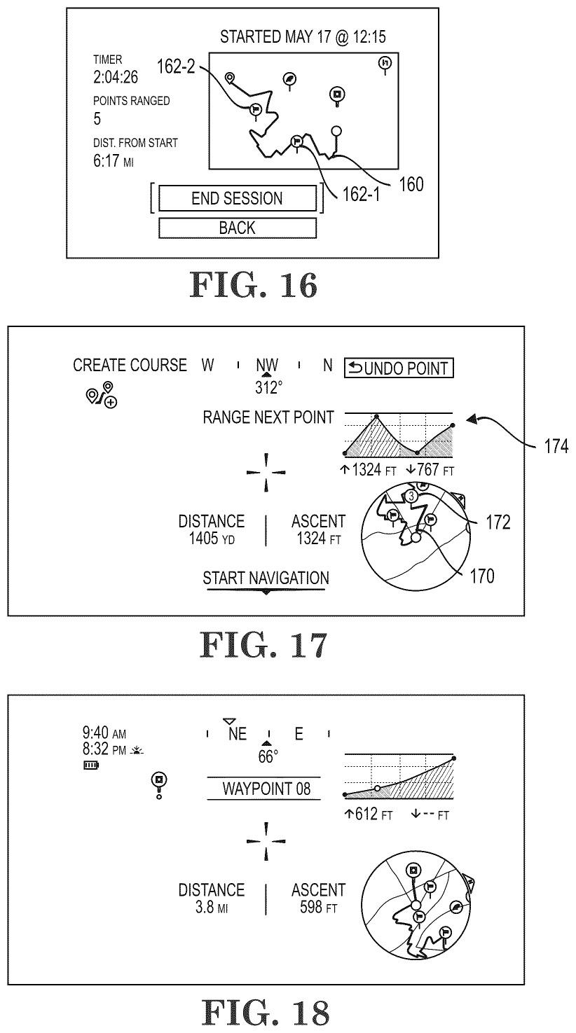

FIG. 16 illustrates an example of a display (e.g., display 108 in FIG. 3) showing augmented reality viewed through an optical system (e.g., optical system 100 in FIGS. 1, 2, 3, and 8). The optical system can be GNSS enabled, such using the GPS functionality described above or other similar systems. This offers the optical system the ability to record and display a track 160 of a user (e.g., user 101 in FIGS. 1 and 8), along with locations 162-1 and 162-2 where the user was when a waypoint was acquired. In some examples, a total time of the excursion along with distance traveled can also be displayed.

FIG. 17 illustrates an example of a display (e.g., display 108 in FIG. 3) showing augmented reality viewed through an optical system (e.g., optical system 100 in FIGS. 1, 2, 3, and 8). The optical system can include a GNSS enabled laser rangefinder (e.g., laser rangefinder 104 in FIG. 3) along with sensors and mapping to allow a user (e.g., user 101 in FIGS. 1 and 8) to create a course 170 to which the user wants to navigate. Multiple points 172 can be recorded via the laser rangefinder. When the points 172 are combined together, the points 172 can create a course 170 for the user to navigate along with an elevation profile 174 of the course 170. The optical system can be used to navigate or the entire course 170 can be sent to a mobile application or peripheral navigation device such as a watch or handheld global positioning system (GPS) to assist with maneuvering along the course 170. Likewise, the mobile application and/or peripheral navigation device can send location information, like waypoints, courses, tracks, and the like, to the optical system 100. For example, the user could mark a waypoint on his or watch, the watch could transmit the waypoint to the optical system 100, and the optical system 100 can provide the display functionality described herein with respect to the transmitted waypoint.

FIG. 18 illustrates an example of a display (e.g., display 108 in FIG. 3) showing augmented reality viewed through an optical system (e.g., optical system 100 in FIGS. 1, 2, 3, and 8). As a user (e.g., user 101 in FIGS. 1 and 8) navigates to each waypoint, the optical system can update its position and indicate a distance to a next waypoint (e.g., waypoint 08) along the course.

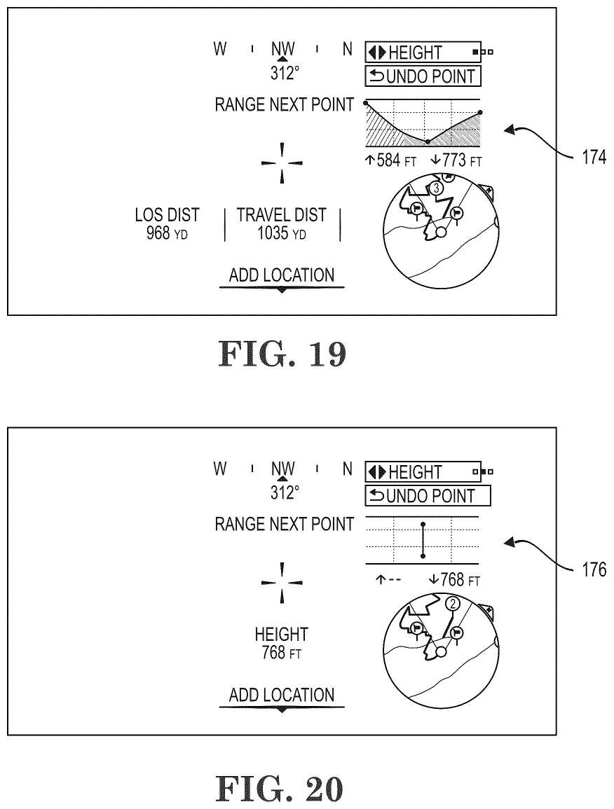

FIG. 19 illustrates an example of a display (e.g., display 108 in FIG. 3) showing augmented reality viewed through an optical system (e.g., optical system 100 in FIGS. 1, 2, 3, and 8). The optical system (e.g., optical system 100 in FIGS. 1 and 8) can include a GNSS enabled laser rangefinder (e.g., laser rangefinder 104 in FIG. 3) along with sensors and mapping to allow a user (e.g., user 101 in FIGS. 1 and 8) to measure distance between points, relative height between points, and/or an area enclosed when three or more waypoints are recorded.

In the present Figure, three points were laser located via the laser rangefinder of the optical system. The user is presented with distances associated with the points, as well as an elevation profile 174 from the first to the final point.

FIG. 20 illustrates an example of a display (e.g., display 108 in FIG. 3) showing augmented reality viewed through an optical system (e.g., optical system 100 in FIGS. 1, 2, 3, and 8). The optical system can include a GNSS enabled laser rangefinder (e.g., laser rangefinder 104 in FIG. 3) along with sensors and mapping to allow a user (e.g., user 101 in FIGS. 1 and 8) to measure distance between points, relative height between points, and/or an area enclosed when three or more waypoints are recorded. In the present Figure, the relative height 176 between points is shown graphically and numerically as 768 feet.

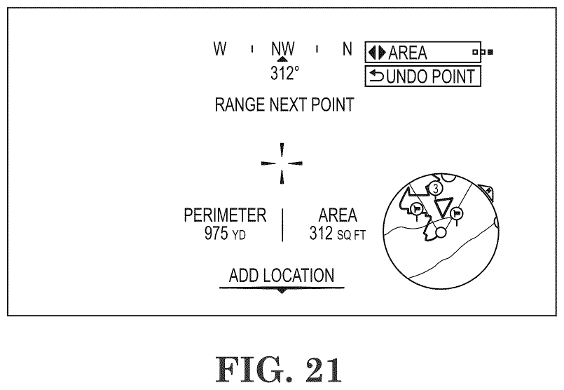

FIG. 21 illustrates an example of a display (e.g., display 108 in FIG. 3) showing augmented reality viewed through an optical system (e.g., optical system 100 in FIGS. 1, 2, 3, and 8). The optical system can include a GNSS enabled laser rangefinder (e.g., laser rangefinder 104 in FIG. 3) along with sensors and mapping to allow a user (e.g., user 101 in FIGS. 1 and 8) to measure distance between points, relative height between points, and/or an area enclosed when three or more waypoints are recorded. In the present Figure, a perimeter and calculated area enclosed by three ranged points is presented to the user numerically as a perimeter of 975 yards and an area of 312 square feet.

In some embodiments, an optical system 100 can transmit location information, such as waypoints, to another optical system 100 to enable shared navigation capabilities between users. The transmission of waypoints may occur via wireless communication protocols, such as Bluetooth, Wi-Fi, satellite transmission systems, and/or dedicated radio frequency channels. Once transmitted, the receiving optical system 100 can display the shared waypoint as an augmented reality indicator overlaid on the visual scene viewed through the optical system. Both optical systems 100 can dynamically update their respective displays with distance, direction, and vertical angle indicators to assist users in navigating toward the shared waypoint. The shared waypoint data may include geographic coordinates, elevation, and any user-defined labels or descriptions. This capability allows multiple users to coordinate navigation efforts, track each other's progress, and converge on the same target location, even when separated by significant distances or obstructed terrain. Additionally, waypoints may be transmitted between optical systems as part of a course or track, enabling collaborative route planning and exploration.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

As used herein, “a number of” something can refer to one or more of such things. As will be appreciated, elements shown in the various embodiments herein can be added, exchanged, and/or eliminated so as to provide a number of additional embodiments of the present disclosure.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An optical system comprising:
a global navigation satellite system (GNSS) receiver;
a laser rangefinder;
an orientation sensor;
a display;
a memory; and
a processor coupled to the GNSS receiver, the laser rangefinder, the orientation sensor, the display, and the memory, wherein the processor is configured to:
show a visual scene viewed through the optical system;
mark a target location in the visual scene using the laser rangefinder in response to receiving a mark command from a user to mark the target location;
create a waypoint of the target location based on data from the GNSS receiver, the laser rangefinder, and the orientation sensor;
store the waypoint in the memory;
load the waypoint in response to receiving a load command to load the waypoint from the user; and
show an augmented reality overlayed by the display on a different visual scene viewed through the optical system, wherein the augmented reality includes an indicator to guide the user to the waypoint.

2. The system of claim 1, wherein the processor is configured to access map data to create the waypoint.

3. The system of claim 1, wherein the data from the laser rangefinder comprises a distance between the laser rangefinder and the target location.

4. The system of claim 1, wherein the data from the laser rangefinder comprises an indication that a distance between the laser rangefinder and the target location is beyond a maximum range of the laser rangefinder;
wherein the processor is configured to access map data and interface the data from the GNSS receiver, the laser rangefinder, and the orientation sensor with the map data to draw a line that intersects with earth to mark the target location that is out of range of the laser rangefinder.

5. The system of claim 1, wherein the augmented reality includes a direction indicator to direct the user in which direction to turn the optical system to view the waypoint, which dynamically changes as the optical system is turned.

6. The system of claim 1, wherein the augmented reality includes a vertical angle indicator to direct the user in which direction to adjust an angle of the optical system to view the waypoint, which dynamically changes as the angle is adjusted.

7. The system of claim 1, wherein the augmented reality includes a stop indicator to direct the user to stop moving in response to the waypoint being within the different visual scene viewed through the optical system on the display.

8. An optical system comprising:
a global navigation satellite system (GNSS) receiver;
a laser rangefinder;
an orientation sensor;
a display;
a memory; and
a processor coupled to the GNSS receiver, the laser rangefinder, the orientation sensor, the display, and the memory, wherein the processor is configured to:
show a visual scene viewed through the optical system;
mark a target location in the visual scene using the laser rangefinder in response to receiving a mark command from a user to mark the target location;
create a waypoint of the target location based on data from the GNSS receiver, the laser rangefinder, and the orientation sensor;
store the waypoint in the memory;
load the waypoint in response to receiving a load command to load the waypoint from the user; and
show an augmented reality overlayed by the display on a different visual scene viewed through the optical,
wherein the augmented reality includes:
a direction indicator, to direct the user in which direction to turn the optical system to view the waypoint, which dynamically changes as the optical system is turned; and
a vertical angle indicator, to direct the user in which direction to adjust an angle of the optical system to view the waypoint, which dynamically changes as the angle is adjusted.

9. The system of claim 8, wherein the direction indicator is green.

10. The system of claim 8, wherein the direction indicator includes a direction of travel.

11. The system of claim 8, wherein the direction indicator includes indicators of north, east, south, and west.

12. The system of claim 8, wherein the vertical angle indicator includes a numerical degree call out.

13. An optical system comprising:
a global navigation satellite system (GNSS) receiver;
a laser rangefinder;
a magnetometer;
a tilt sensor;
a display;
a memory; and
a processor coupled to the GNSS receiver, the laser rangefinder, the magnetometer, the tilt sensor, the display, and the memory, wherein the processor is configured to:
show a visual scene viewed through the optical system;
mark a target location in the visual scene using the laser rangefinder in response to receiving a mark command from a user to mark the target location;
create a waypoint of the target location based on data from the GNSS receiver, the laser rangefinder, the magnetometer, and the tilt sensor;
store the waypoint in the memory;
load the waypoint in response to receiving a load command to load the waypoint from the user; and
show an augmented reality overlayed by the display on a different visual scene viewed through the optical system on the display, wherein the augmented reality includes a stop indicator, to direct the user to stop moving, which is displayed when the waypoint is in the different visual scene.

14. The system of claim 13, wherein the stop indicator includes a green circle.

15. The system of claim 13, wherein the processor is configured to determine a distance to the waypoint based on the data from the GNSS receiver, the laser rangefinder, the magnetometer, and the tilt sensor.

16. The system of claim 15, wherein the augmented reality includes the distance to the waypoint.

17. The system of claim 13, wherein the processor is configured to transmit the waypoint to another device.

18. The system of claim 13, wherein the augmented reality includes map information.

19. The system of claim 13, further comprising an accelerometer in a monocular of the optical system.

20. The system of claim 19, wherein the processor is configured to:
determine an angle of rotation based on a reading taken by the accelerometer; and
rotate information on the display to the angle of rotation.
